(19) United States
(12) Patent Application Publication
(10) Pub. No.: US 2004/0139639 A1
(43) Pub. Date: Jul. 22, 2004

(54) Display sign assembly

(76) Inventors: Kenneth A. Shwartz, Mattapoisett, MA (US); Charles Lord, Mattapoisett, MA (US); Anthony Matias, New Bedford, MA (US)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/345,848

(22) Filed: Jan. 16, 2003

(51) Int. Cl. G09F 15/00

(52) U.S. Cl. 40/607.01

(57) ABSTRACT

An display sign assembly for use in connection with a display platform at a point of purchase. The assembly includes an elongated support having a first end and an opposite end. The assembly further includes a display surface at the first end and an extension at the second end for anchoring the assembly in an opening on the display platform. The assembly also includes a stop at a juncture between the second end of the support and the extension, so as to prevent the support from falling through the opening. The stop can also act to provide lateral stability to the assembly.

### TECHNICAL FIELD

The present invention relates generally to a display sign assembly, and more particularly, to an assembly for use in connection with a display table and designed to permit interchangeability of display signs.

### BACKGROUND ART

Retail establishments, such as department stores, have used display signs for quite some time to provide information to the customers regarding the items being displayed or to focus the attention of the customers toward the items being displayed. Various displays have been employed by these establishments ranging from display signs permanently secured to a support structure, such as a garment rack, or to portable display stands that can be moved from one area of the store to another, for instance, from one display table to another display table.

Despite the general usefulness of these display signs, certain impracticality remains. For example, in the event that a change of the display sign is needed to reflect a change in the product being displayed, access to a display sign that is, for instance, permanently secured to a support structure, such as a garment rack, may be difficult, especially when the rack is full of garment. As for the portable display stands, such as those typically positioned on a display platform, for example, a display table, since such a stand is often small and light, it can be easily knocked over by a customer. A fallen stand, as a result, can be disruptive to those customers shopping nearby, and can also create unwanted hazards to the customer who initially accidentally knocked down the sign.

Further, as certain up-scale establishments have a desire to maintain an upscale and/or professional image, display stands or signs that are obstructed, knocked down, or otherwise not visible to the customer, can affect the image the establishment is trying to convey and may fail to draw consumer attention toward the displayed product, the result of which can ultimately hurt sales.

Accordingly, there is a need for a stable display stand or support structure that can easily accommodate changes, be easily moved, that is easily visible, and that can remain substantially secured to a display area to avoid or to minimize any potential hazards associated with a fallen stand or support structure.

### SUMMARY OF THE INVENTION

The present invention, in accordance with one embodiment, provides a display sign assembly which is stable, easily changed, and unobstructed from view at a point of purchase. The assembly, in one embodiment, includes an elongated support having a first end and an opposite second end. The assembly further includes, at the first end of the support, a display surface upon which a display sign can be placed. At the second end of the support, there is provided an extension that is situated within a same plane as the support. The extension, in an embodiment, can be received within an opening on a display platform located at a point of purchase, and includes a length sufficient to anchor the support and maintain the support in an upright position. The assembly can also be provided with a stop at a juncture between the second end of the support and the extension, so as to prevent the support from falling through the opening. The stop, in one embodiment of the invention, includes a circumference relatively larger than that of the extension and of the opening to prevent the support from falling through the opening and to provide the assembly with lateral stability.

In accordance with another embodiment of the invention, a method for displaying a sign at a point of purchase is provided. The method includes, providing a display sign assembly having an elongated support, a display surface upon which a sign can be placed at one end of the support, an anchor at an opposite end of the support, and a stop located between the support and the anchor. Thereafter, an opening having a profile capable of accommodating the anchor and having a circumference relatively smaller than that of the stop may be located on a display platform, such as a display table, located at a point of purchase. Subsequently, the anchor may be placed within the opening until the stop engages the display platform, so as to prevent the support from falling through the opening, and to provide lateral stability to the assembly. In accordance with one embodiment, should an opening not exist on the display platform, one can be generated for use.

The method further provide, in an embodiment, replacement or exchange of the display sign assembly. In particular, the existing assembly may be removed from the displayed platform until the anchor is displaced from the opening. Next, a new display sign assembly may be provided. Thereafter, the anchor on the new assembly may be placed within the opening until the stop engages the display platform, so as to again prevent the support from falling through the opening and to provide lateral stability.

### BRIEF DESCRIPTION OF THE DRAWINGS

FIG. 1 illustrates a perspective view of a display sign assembly used in connection with a display platform at a point of purchase, in accordance with one embodiment of the present invention.

FIG. 2 illustrates a display sign assembly in accordance with one embodiment of the present invention.

FIG. 3 illustrates an anchor end of the assembly shown in FIG. 2.

FIGS. 4A-B illustrate an various anchor designs for use in connection with the assembly of the present invention.

FIGS. 5A-B illustrate a cover for the opening shown in FIGS. 4A-B when the display sign assembly is not in use.

### DETAILED DESCRIPTION OF SPECIFIC EMBODIMENTS

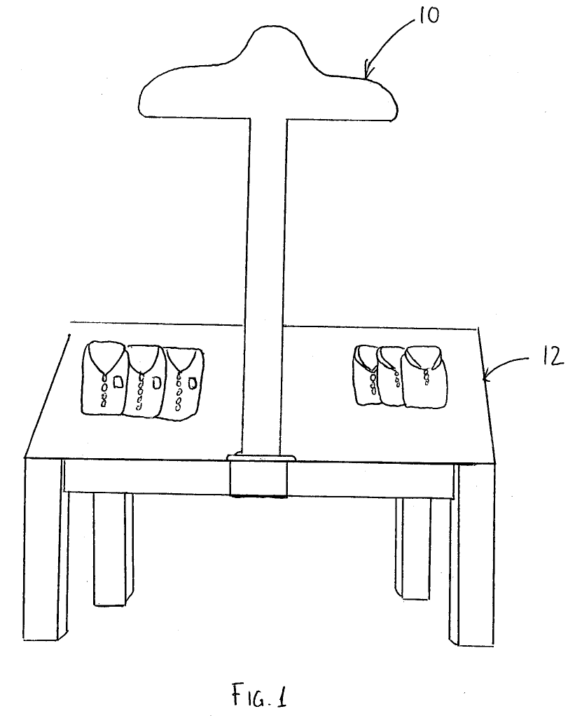

The present invention provides, as illustrated in FIG. 1, a display sign assembly 10 for use in connection with a display platform 12, such as a display table, located at a point of purchase, for example, in a department store. One purpose of the display sign assembly 10 may be to draw the attention of customers to the display platform 12, and to provide information regarding the products being displayed.

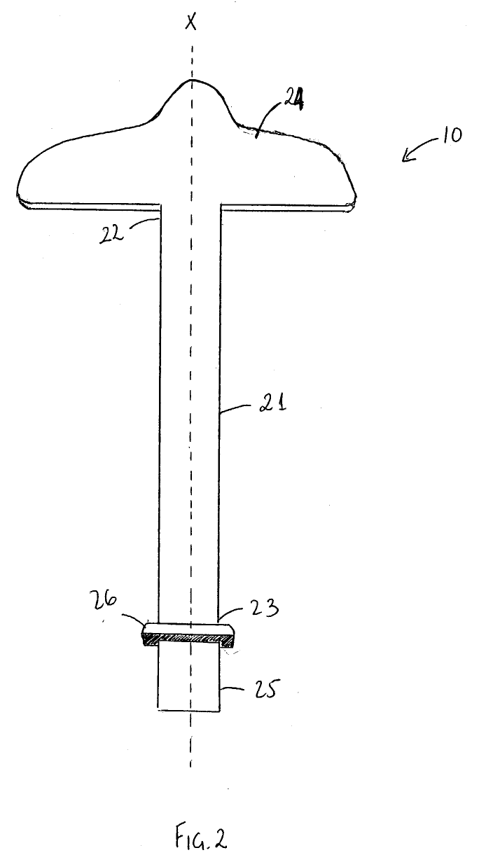

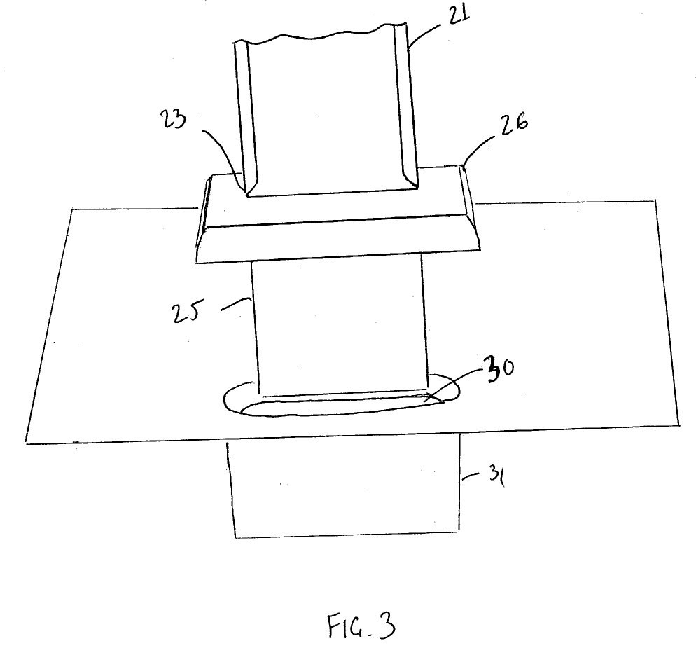

Looking now at FIGS. 2 and 3, there is shown the display sign assembly 10 illustrated in FIG. 1. The assembly 10 includes, in one embodiment, an elongated support 21, extending along an axis X, and having a first end 22 and an opposite second end 23. The assembly 10 includes, at the first end 22 of the support 21, a display surface 24 upon which a complementarily shaped display sign can be placed. As shown in FIG. 2, the display surface 24 may include a width that is relatively larger than that of the support 21, so that information regarding the displayed product may be provided thereon. In addition, although illustrated with a particular geometric shape and size in FIG. 2, it should be noted that the display surface may be of any shape or size, so long as information about the displayed product can be provided thereon.

The assembly 10 further includes, at the second end 23 of the support 21, an extension 25 for anchoring the support 21 and maintaining it in an upright position within an opening 30. The extension 25, in one embodiment, may be situated within a same plane as the that of the support 21 and may extend from the second end 23 along the same axis X of the support 21. The extension 25 can be designed so that it will be received within a complementary opening 30 on the display platform 12 placed at a point of purchase. However, it should be noted that, as shown in FIG. 3, the opening 30 does not need to be of a similar profile as the extension 25. As the extension 25 must act as an anchor for the support 21, the extension 25 may be provided with a length sufficient to stably anchor the support 21 within the opening 30. In addition, the extension 25 is preferably of a sufficient length to maintain the support 21 in an upright position, while minimizing the chances of the assembly 10 from being accidentally knocked over. To that end the extension 25 may be provided with a length that is relatively longer than the thickness of the opening 30 through the platform 12.

To further enhance the stability of the assembly 10 when the extension 25 is positioned within the opening 30, a pocket 31 may be placed under the opening 30 to provide an area within which the extension 25 may sit. As shown in FIG. 3, the pocket 31 may be similar in shape to the extension 25 but with dimensions that would permit some play while the extension 25 is within the pocket 31, so as to allow easy removal of the extension 25 therefrom. By providing such a pocket, any lateral movement of the support 21 will cause the extension 25 to hit a side of the pocket 31 to prevent the assembly 10 from falling out of the opening 30.

The assembly 10 can also be provided with a stop 26 at a juncture between the second end 23 of the support 21 and the extension 25. By providing stop 26 at such a juncture, the support 21 may be prevented from falling through the opening 30. To that end, the stop 26, in one embodiment of the invention, may be designed to include a circumference relatively larger than that of the opening 30. The stop 26, with its circumference being relatively larger than that of the opening 30, can act to cover the opening 30 substantially completely, and can also provide the assembly 10 with additional lateral stability.

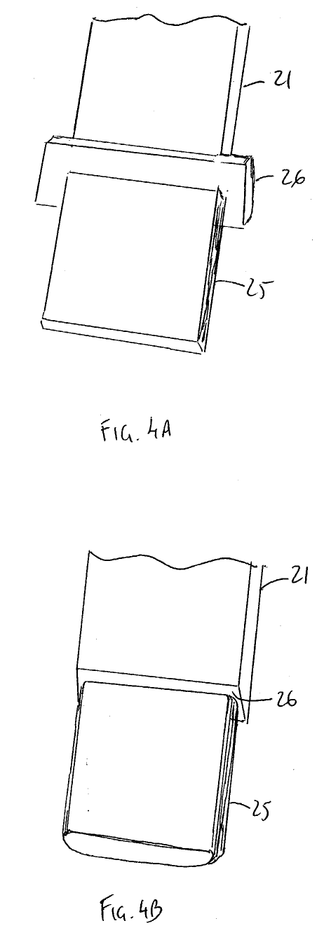

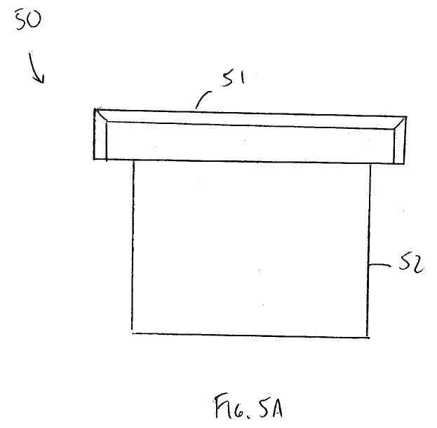

In an alternative embodiment, the stop 26, as illustrated in FIG. 4B may be provided with a thickness or circumference substantially similar to that of the support 21, while being relatively thicker than the extension 25. With this design, the stop 26 is essentially a ledge formed between an end surface of the support 21 and the periphery of the extension 25. To prevent the support 21 from falling through opening 30 in this embodiment, opening 30 should be designed to include a circumference that is smaller than that of the support 21.

Regardless of the design, it should be noted that the extension 25 should be provided with dimensions that would permit it to be easily removed from the opening 30, but would not permit it to be. In certain embodiments, as shown in FIG. 4A, the extension 25 may be designed to include a cross-sectional geometric profile, for instance, rectangular or elliptical, that is similar to that of the support 21. Alternatively, as shown in FIG. 4B, the extension 25 may be designed to include a cross-sectional geometric profile, for instance, elliptical, that is distinct from that of the of the support 21, for example, rectangular.

It should be noted that when in place, the height of the support 21 and size of the display surface 24, as shown in FIG. 1, permit the a sign on the display surface 24 to tower over the product being displayed. In this manner, the sign on the display surface 24 can be seen substantially unobstructedly by a customer, and can assist a customer in locating the display platform 12 of interest from afar.

As the assembly 10 may be used to display a sign in an upright position, the assembly 10 may be made from a solid and rigid material. The material from which the assembly 10 may be made includes wood, compressed wood particles, metal, metal composite, molded plastic, a combination of any of these, or any other comparable rigid materials.

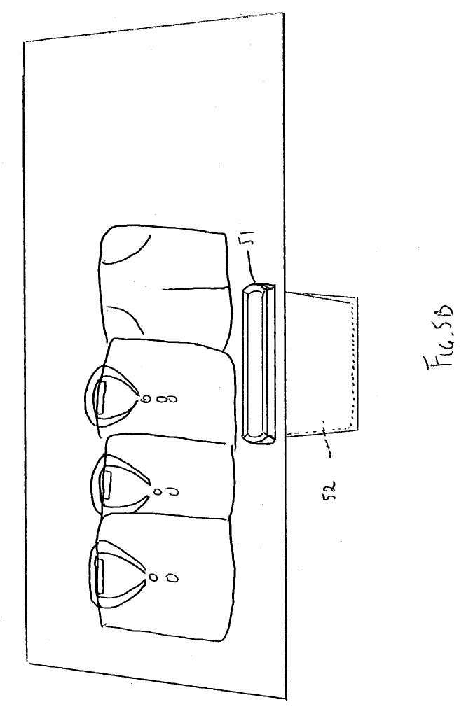

Looking now at FIGS. 5A-B, there is shown cover 50 for placement over the opening 30 when the display sign assembly 10 is not in use. The cover 50 includes a top portion 51 and a bottom portion 52 connected thereto. The top portion 51, in an embodiment, may be designed to include a circumference that is relatively larger than the opening 30, so that when the cover 50 is in position, the top portion 51 can act to cover the opening 30 substantially completely. The bottom portion 52, on the other hand, can be similar to the extension 25 in size and shape. When the cover 50 is in use, the bottom portion 52 may be received within the opening 30 to maintain the position of the cover 50 over the opening 30 and prevent any accidental displacement of the cover 50 therefrom.

In use, the assembly 10 may be placed at a point of purchase along with a sign on its display surface 24 to direct customer attention to the product being displayed. In one embodiment, prior to positioning the assembly 10 in place, opening 30 on display platform 12 needs to be located. If one does not exist, and it is desired that assembly 10 be displayed, then an opening 30 needs to be generated, for instance, by cutting an opening through the display platform 12, or by any method known in the art. Once the opening has been generated, the assembly 10 can be placed over the opening 30, such that extension 25 is aligned with the opening. Thereafter, the extension 25 may be urged into the opening 30 until the stop 26 engages the display platform 12. In this manner, the extension 25 in conjunction with the opening 30, and the stop 26 can act to provide the support 21, and thus the assembly 10, with lateral stability. The stop 26 can further act to prevent the assembly 10 from falling through the opening 30.

Should a change or replacement of the assembly 10 on the display platform 12 is desired at the point of purchase, the assembly 10 may be removed from the display platform 12 until the extension 25 is displaced from the opening 30. A new assembly 10 may then be provided with a new sign on the display surface 24 of the assembly 10. Thereafter, the new assembly 10 may be positioned over the opening 30 and the extension 25 urged thereinto until the stop 26 engages the display platform 12.

While the invention has been described in connection with the specific embodiments thereof, it will be understood that it is capable of further modification. For example, although display platform 12 on which the opening 30 is positioned has been referenced as a display table, it should be appreciated that the platform 12 can be any surface on which an opening 30 may be provided, and can also be a step-up platform which is secured to, for instance, the surface of the display table. Regardless of the surface used, such surface should permit the assembly 12 to be placed in the opening 30 and easily removed therefrom. Furthermore, the assembly 10 may be made of any size and/or shape, so long as it is capable of being retained in the opening 30. This application is intended to cover any variations, uses, or adaptations of the invention, including such departures from the present disclosure as come within known or customary practice in the art to which the invention pertains, and as fall within the scope of the appended claims.

What is claimed is:

1. A display sign assembly for use at a point of purchase, the assembly comprising:
an elongated support having a first end and a second end;
a display surface positioned at the first end of the support;
an extension, situated within a same plane as the support and projecting from the second end, for receipt within an opening on a platform at a point of purchase to anchor the support and maintain it in an upright position; and
a stop located at a juncture between the second end of the support and the extension for preventing the support from falling through the opening.

2. An assembly as set forth in claim 1, wherein the elongated support is made from a rigid material.

3. An assembly as set forth in claim 2, wherein the rigid material includes one of wood, wood particles, metal, metal composite, or a combination of any of these.

4. An assembly as set forth in claim 1, wherein the display surface includes a width relatively larger than that of the support to accommodate a complementarily large display sign.

5. An assembly as set forth in claim 1, wherein the extension includes a length sufficient to anchor itself within the opening, so as to permit the support to remain upright.

6. An assembly as set forth in claim 1, wherein the extension includes a shape which complement that of the opening.

7. An assembly as set forth in claim 1, wherein the stop includes a substantially similar thickness to that of the support while being relatively thicker than the extension to provide the assembly with lateral stability.

8. An assembly as set forth in claim 1, wherein the stop includes a circumference relatively larger than that of the opening and the support to provide the assembly with lateral stability.

9. An assembly as set forth in claim 1, wherein the support and the extension are designed to include similar geometric shape cross-sectionally.

10. An assembly as set forth in claim 1, wherein the support and the extension are designed to include different geometric shape cross-sectionally.

11. A method for displaying a sign at a point of purchase, the method comprising:
providing a display sign assembly having an elongated support, a display surface upon which sign can be placed at one end of the support, an anchor at an opposite end of the support, and a stop located between the support and the anchor;
locating, on a display platform at a point of purchase, an opening having a circumference relatively smaller than that of the stop; and
placing the anchor within the opening until the stop engages the display platform to prevent the support from falling through the opening and to provide lateral stability to the assembly.

12. A method as set forth in claim 11, wherein locating, includes generating an opening on the display platform in the event the opening previously did not exist.

13. A method as set forth in claim 11, further including:
removing the assembly from the display platform until the anchor is displaced from the opening;
providing a new display sign assembly having an elongated support, a display surface at one end of the support, an anchor at an opposite end of the support, and a stop located between the support and the anchor; and
placing the anchor of the new assembly within the opening until the stop engages the display platform to prevent the support from falling through the opening and to provide lateral stability to the new assembly.
